(19) United States
(12) Patent Application Publication
(10) Pub. No.: US 2017/0353579 A1
(43) Pub. Date: Dec. 7, 2017

(54) Lifetime Achievement Line

(71) Applicant: Cornelius John Vanderkolk, Salt Lake City, UT (US)

(72) Inventor: Cornelius John Vanderkolk, Salt Lake City, UT (US)

(21) Appl. No.: 15/173,983

(22) Filed: Jun. 6, 2016

(51) Int. Cl. H04L 29/08; H04L 12/58; G06Q 30/02; G06Q 50/00

(52) U.S. Cl. CPC H04L 67/306; H04L 67/02; G06Q 30/0279; H04L 51/32; G06Q 50/01

(57) ABSTRACT

A system for acknowledging and recording lifetime achievements of a user's philanthropic activities through a socially accessible philanthropic chronological profile has been disclosed. The system includes a database containing philanthropic data and profile information of several users and a web coding mechanism to organize and display data found on said database into a socially accessible philanthropic chronology that is online and automated. Each automated lifetime achievement award is socially accessible and can evolve and expand throughout time as and when new philanthropic data becomes available, thus avoiding the need for issuing separate awards to acknowledge a profile user's achievements and contributions.

### PRIORITY STATEMENT

The present application claims priority to U.S. Provisional Application No. 62190886 filed on Jul. 10, 2016. The contents of that application are incorporated herein by reference.

### TECHNICAL FIELD OF INVENTION

Present invention relates to a system and method for tracking, recording and displaying a user's philanthropic activities in the form of an online automated chronological profile that is open to public access.

### BACKGROUND OF THE INVENTION

Online fundraising has become a common phenomenon in the recent years. Several online portals have mushroomed that seek to accumulate donations from the general masses for different social causes. But unfortunately, little has been done to motivate the donors by returning to them proper recognition that can facilitate in their SEO, SMM and PR strategies. More notably, no efforts have been made to give proper recognition to the contributors who make fundraising successful. Be it an individual or an organization, due to lack of a proper mechanism that keeps track of philanthropic activities, it is ultimately left to the third parties to give recognition to such individuals and entities for their contribution. And even if a recognition is granted, it is either drafted manually for each achievement or milestone, which makes it non-uniform and is dispensed long after the effort was made, making the award itself redundant to a great extent.

Similarly, donors starting with high level of enthusiasm often find it difficult to motivate themselves for no effort is made to keep track of their efforts and provide them recognition for their hard work. Poor SEO techniques and orthodox system of text only follow up mails (that acknowledge the receipt of the donation privately) with no genuine effort towards institutionalizing such philanthropic activities also contribute in the depreciation of a volunteer's interest in engaging in noble causes.

Very little has been done to actually address the problem of non-recognition of donors and to incentivize online fundraising by making efforts to inform general public about the philanthropic contributions made by an individual or an organization. There is no other invention that provides a comprehensively uniform forum that awards users for their fundraising efforts made towards any social cause.

What is needed is a system that acknowledges the life time achievements of a user in an automated and uniform manner that keeps information about all philanthropic contributions made in user's life-span. There is a dire need to have a system that constantly updates information about the philanthropic activities of various users on a single platform and also allows general public to see the number of such activities undertaken by a particular user by making it socially visible.

### BRIEF SUMMARY OF THE INVENTION

The present invention comprises a system and methods for developing an online automated socially accessible philanthropic chronological profile “Life-Time-Achievement-Award” which has multiple components that facilitates the creation and display of a socially accessible and viewable philanthropic chronology. The chronology enlists the life-time-achievement-award for the profile user that can be used to support areas including, but not limited to, public-relations, social-media, and SEO tactics or solutions.

The present invention provides uniform automated life-time-achievement-awards to acknowledge the philanthropic contributions of each individual profile user. The invention tends to do that by allowing users to make their profiles on a secure channel and maintain a database that keeps a record of all the philanthropic activities of users. On the basis of their individual contributions, users are awarded a chronology with accompanied tallies and philanthropic details which are publicly displayed on an online life-time-achievement-award.

In one aspect of the present invention, the contributions made by a user are acknowledged automatically in the form of award and are constantly updated on his/her profile which is displayed on his lifetime achievement line. In a seamless fashion, the lifetime achievement award expands with the number of philanthropic engagements and thus keeps expanding with the new philanthropic data being updated. The evolving nature of award thus addresses the need for issuing separate awards for separate contributions.

In another aspect of the present invention, the invention provides a “social-currency value” for each profile with the flexibility for the chronology to evolve when new philanthropic information becomes available. Social Currency Value of a profile user assists a third party to access and compare the philanthropic engagements of different profile users. An interested entity can thus decide about making business engagements by choosing the company that best suits its philanthropic endeavors. For example: Bob is looking for a lighting company in his community to service his commercial buildings. He sees company A and company B online to choose from. Because Bob knows nothing of either because they are new to him, he checks out the online reviews of both. Seeing that reviews are mostly the same, Bob also looks at Life-Time-Achievement-Lines that company A and B linked to on their homepage. Bob sees that company A is much more heavily involved in community philanthropy than B. Bob feels excited that choosing company A will not only suit his needs, but will also indirectly support and aid his community's interest in a way Bob identifies with.

In another aspect of the present invention, the automated philanthropic award information is not only publicly accessible, but is also open to sharing on various social networking forums. This aspect of the invention thus allows users to share their contribution, which is in the form of lifetime achievement award, with other users and is thus not merely confined to admin and user's own viewing.

### BRIEF DESCRIPTION OF THE DRAWINGS

FIG. 1 is a website screenshot displaying the user's profile page when he/she logs in for the first time.

FIG. 2 is a website screenshot showing various components of the invention for creating a campaign.

FIG. 3 is a website screenshot showing various components of the inventions for creating an auction.

FIG. 4 is a schematic diagram showing the Lifetime achievement award as it is shown on user's profile after campaigns are created.

FIG. 5 is a schematic diagram showing various components of the present invention and the manner in which they co-ordinate with each other.

FIG. 6 is a schematic diagram giving details about items that are displayed on a user's profile.

FIG. 7 is a schematic diagram giving enhanced detail of a lifetime achievement award individually.

FIG. 8 is also a schematic diagram showing the functioning of the system with a specific reference to the award part and the manner in which the core components of the invention co-ordinate with each other to produce the desired output.

### DETAILED DESCRIPTION OF THE SPECIFIC EMBODIMENTS:

The preferred embodiment of the present invention is being disclosed in this section by making a reference to the accompanying drawings.

All through the specification, the technical terms and abbreviations are to be interpreted in the broadest sense of the respective terms, and include all similar items in the field known by other terms, as may be clear to persons skilled in art. Restriction or limitation if any referred to in the specification, is solely by way of example and for understanding the present invention. Also, there is no stringent rule as far as the visual layout of the award is concerned. Placing of visual components like icons and form entries are for explanation purposes and the invention would cover all other variants that seek to achieve the same objection as that of the present invention.

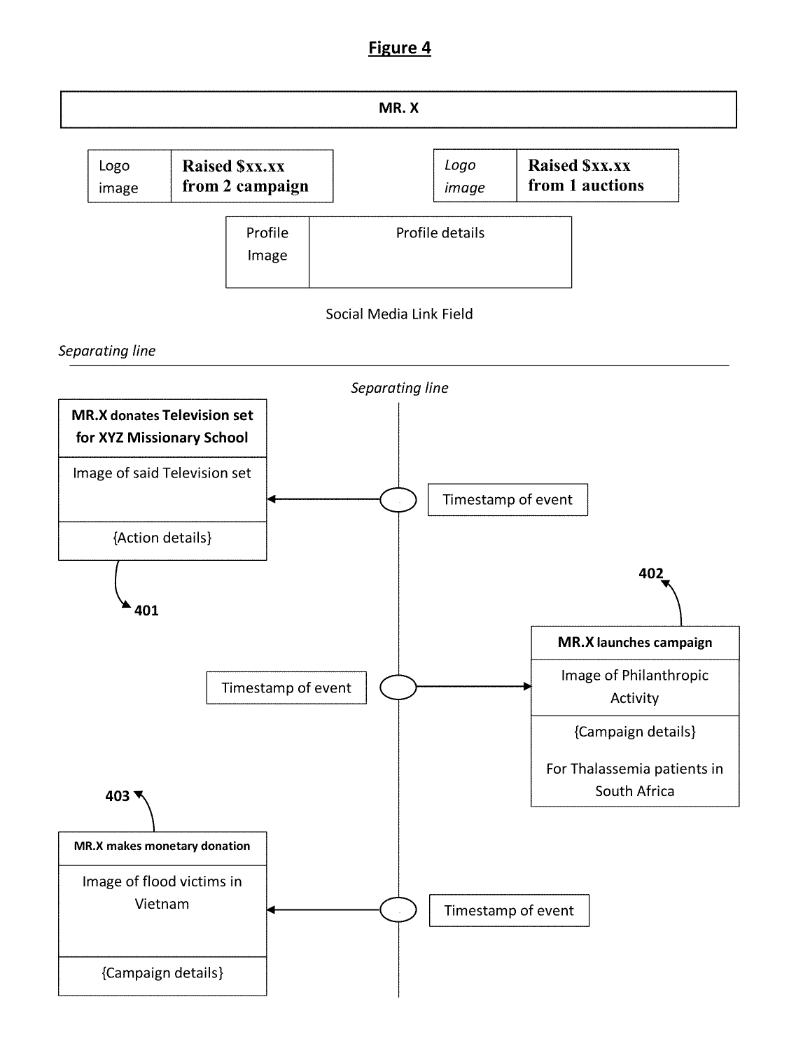

For instance, FIG. 4 shows philanthropic profile displaying lifetime achievement award of one user on a PC-based system interface that operates through internet connection. But it's obvious that the system interface can operate on other devices like a smartphone or tablet also through any other mechanism to facilitate connectivity like LAN, WAN, WAP etc. The disclosure is only of the preferred embodiments, but not the only embodiments.

Turning first to the nomenclature of the specification, the detailed description that follows is represented largely in terms of system block diagrams, flow charts, website screenshots, processes and symbolic representations by conventional computer components. These symbolic representations are the means used by those skilled in the art of computer programming and computer construction to most effectively convey teachings and discoveries to others skilled in the art.

The present invention is directed to a method and system for developing an online automated socially accessible philanthropic chronological profile “Life-Time-Achievement-Line” for purposes including, but not limited to, giving recognition to a user for conducting philanthropic activities with an object to promote and incentivize users to indulge in such activities in future also. In the preferred embodiment, the invention is an intelligent scheme that functions on a website which is accessible to everyone having internet connectivity. The function of the website includes, but is not limited to, displaying a linear chronology showing various philanthropic activities conducted by a profile user in a chronological order that is made socially accessible, and can be further promoted by the user through various social networking platforms functional on the internet.

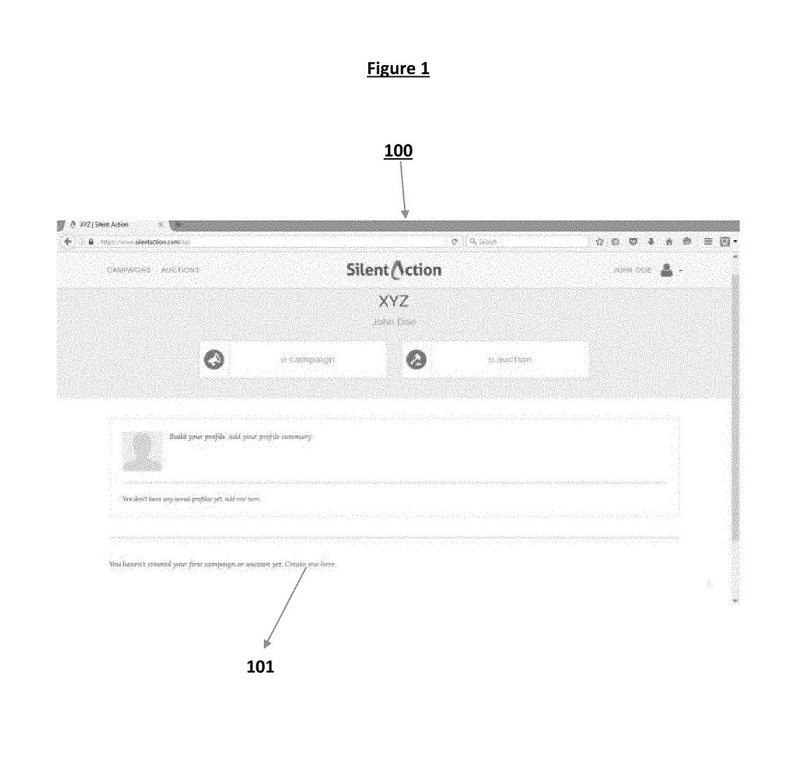

The website and its various features explained via FIG. 1 to FIG. 8 are hosted on a web server like a Virtual Private Server. Any user/client can connect to the web server through public internet via HTTP and IP protocols. Special Versions designed for smartphones and tabs can be connected via Wireless Access Protocol (WAP). The lifetime achievement line system displays a homepage with an option of sign up to facilitate creation of user account. By clicking on the sign up option, the user can register himself on the secured local server by entering his personal details like name, organization, e-mail id and set a password. Upon clicking the ‘submit’ option, user then receives a confirmation mail to the e-mail id that he provides and his sign-up process gets him/her registered with the website server.

FIG. 1, is a preferred embodiment of the present invention showing a visual representation of how the page initially looks like when a user logs in for the first time on the forum. The profile-screen 100 shows the name of the user and the organization that he entered while signing up for the process; a campaign link that upon clicking, gives detail of all campaigns running on the website by other users; an auction link that upon clicking, gives details of all auctions running on the website by other users; a choice of logging out or making changes in the profile and for making withdrawals of the raised funds; an option to build the profile by allowing users to create summarized information about themselves, provide organization's website and urls to access their online social networking forums. An option like “Create one here” 101 option shown in the FIG. 1 to provide that user with the means for creating a campaign or an auction by a simple click of the mouse.

### Part A: Campaigns

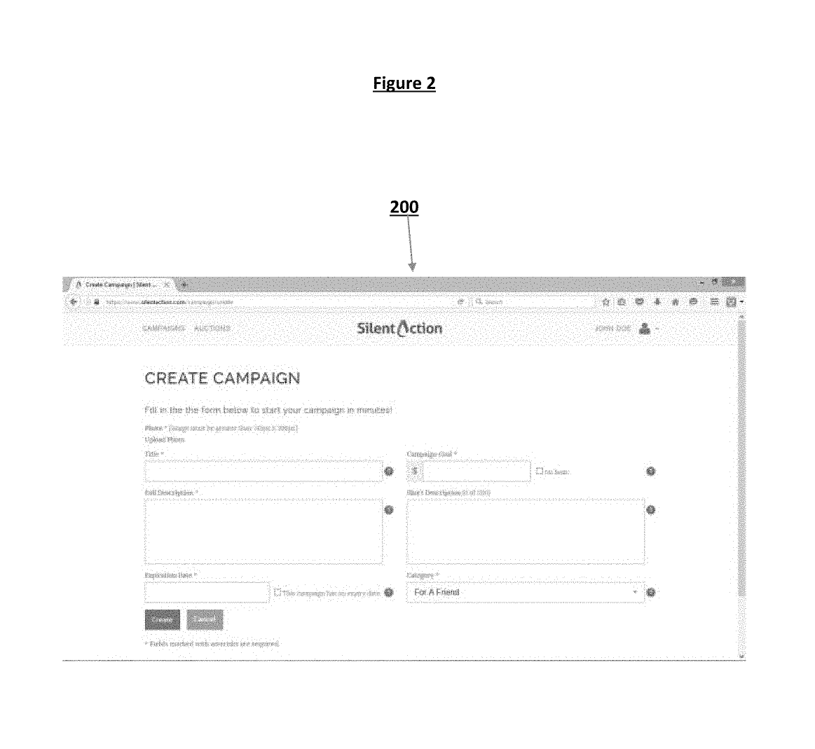

For creating a campaign, upon clicking the “create campaign” icon, user will be required to fill out a standard form 200 as shown in FIG. 2 which will contain details like a Photo to be uploaded, the title of the campaign, campaign's goal in terms of money to be raised, an option like “Full Description” providing a vivid description of the campaign, an option like “Short Description” that will be visible on the listing pages, an expiration date and a category stating the entity or person for which the campaign will be built. And finally an option to create or cancel to finalize the contents or to annul creation of the campaign respectively. In other embodiment, form appearing on the website may be replaced by a questionnaire, that may or may not be online, seeking all requisite details required for creating a philanthropic campaign.

Upon creation the system and method allows a user to manage his forum by allowing him to make alterations through various methods including but not limited to making edits to the campaign, duplicating the campaign, publishing it, deleting it, sharing it on social media and so on. While duplicating option allows a user to create a new campaign by taking a cue from the already existing ones, publishing option allows user to launch the campaign or auction, as the case may be, and go live on the internet. The preview page shows an additional option to create a sub-campaign which can be created by anybody apart from the original user to make a donation. Sub-campaigning allows a philanthropist, who is not the user or creator of a campaign cause, to help support the campaign by creating a sister campaign within the parent campaign. The option allows a sub-campaigner to set up a personal goal and accept support from his own circle to supplement the parent cause.

In another embodiment of the present invention, there can be no limit to the Campaign Goal or the amount proposed to be raised by the campaign and to the expiration date so that the campaign could run indefinitely.

### Part B: Auctions:

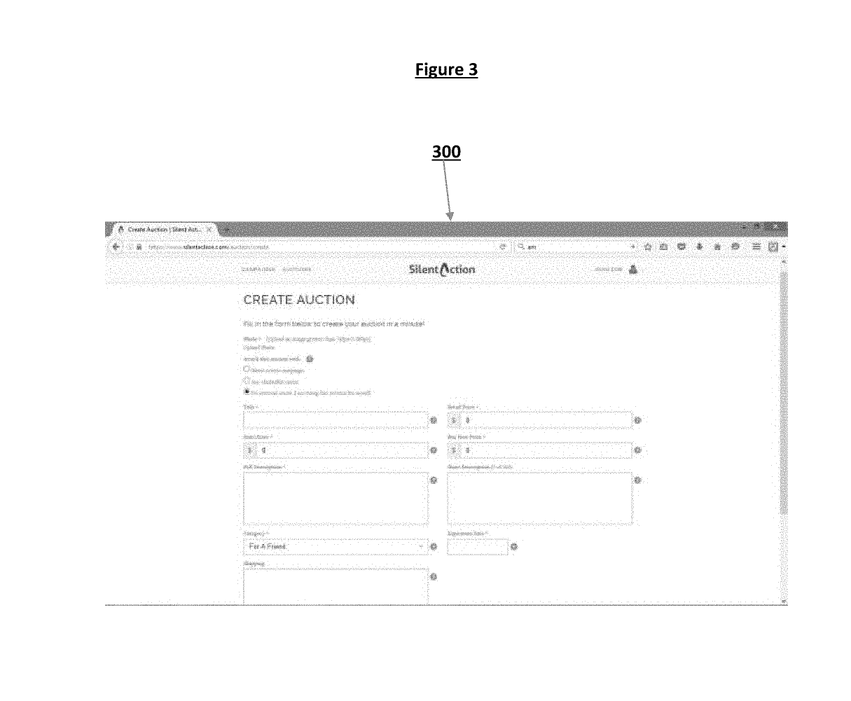

For creating an auction, upon clicking the “create auction” icon, user will be required to fill out a standard form 300, as shown in FIG. 3, which will contain details like a Photo (which may or may not be the item to be auctioned), the title of the auction, retail price of the item being auctioned, a base price from which the auctioneers would start bidding, a buy now price which would allow a bidder to purchase the item right away and end the bid, a “Full Description” option providing a vivid description of the campaign, a Short Description that will be visible on the listing pages, an expiration date, a category stating the entity or person for which the auction is to be conducted and an option to provide shipping information like the shipping charges that will be incurred to send the auctioned product from user to the bidder and other relevant measures regarding shipping that user has taken while creating the auction event. In other embodiment, form appearing on the website may be replaced by a questionnaire, that may or may not be online, seeking all requisite details required for creating a philanthropic auction.

In another embodiment of the present invention, the form would provide for additional option to attach the auction with any existing campaign found active in the database (which may or may not be created by creator of the auction). This can be done by providing an additional column with multiple options like “attach this auction with” a Silent Action campaign, any charitable cause, etc. like shown in FIG. 3. Upon creation, the system and method allows a user to monitor his auction by facilitating alterations through various methods including but not limited to making edits to the auction, duplicating the auction, publishing it, deleting it, sharing it on social media, previewing it and so on.

In one embodiment of the present invention, the contributions made by a user are acknowledged automatically in the form of award and are displayed on his/her profile on his lifetime achievement line. The lifetime achievement award includes, but is not limited to, monetary tallies, silent auction tallies and donation descriptions, fundraising details, time stamps and donator information. A campaign ran by a registered user or any donation made by such user for any charitable purpose will become apparent on its profile in the form of a block template that will be shown on a geometrical line displaying such contributions in the order of dates on which they were made. For instance, in FIG. 4, Mr X, a registered user's profile will show the following posts on his Lifetime Achievement Line: Mr.X donates a Television set for XYZ missionary school 401; Mr.X launches a campaign to help thalassemia patients in South Africa 402; Mr.X makes monitory donation for Flood Victims in Vietnam 403.

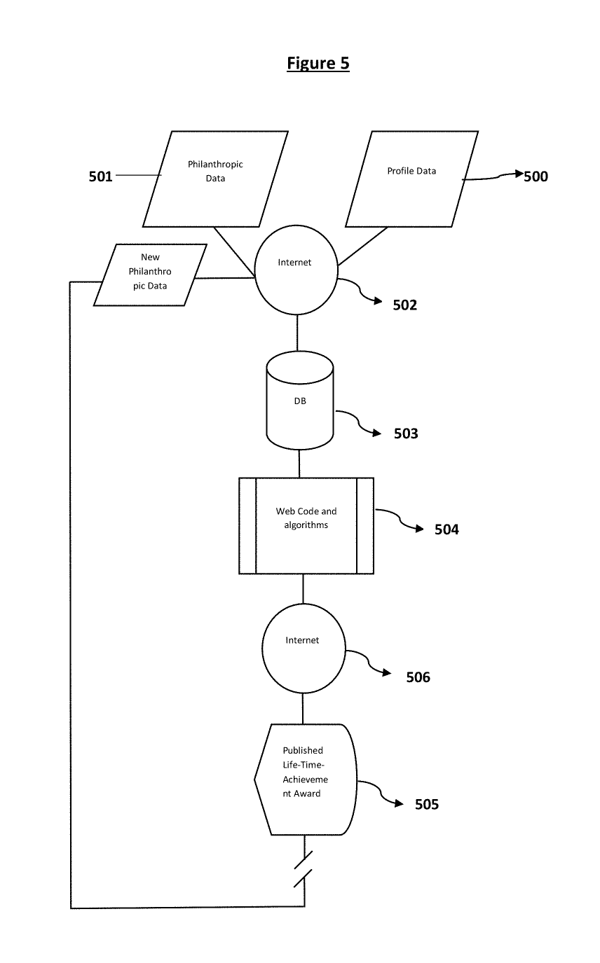

FIG. 5 of the invention shows a perspective view of the present invention that is necessary to explain this aspect of the invention. The information collected regarding philanthropic data 501 and user's profile data 500 will be stored and found on the philanthropic website data base 503 which remains online 502. The information in the database is processed through an algorithm in the web coding 504 that pairs the contributor (Profile Data) to the cause information 501 where a contribution was made, and displays data found on said database into a socially accessible/visible philanthropic award 505 that is online 506 and automated for the profile(s) found on the database. The software accesses information stored in the website database which user can witness through a “page load” event of the Life-Time-Achievement-Line page to analyze:

a. who is the current user of the profile being viewed?
b. which campaigns and auctions did the user created?
c. which campaigns did the user participate in that the user did not create?
d. For each of those campaigns and auctions, how much money was raised?
e. Then, add up the results yielded in Step (a, b, c, and d) and show on the page.

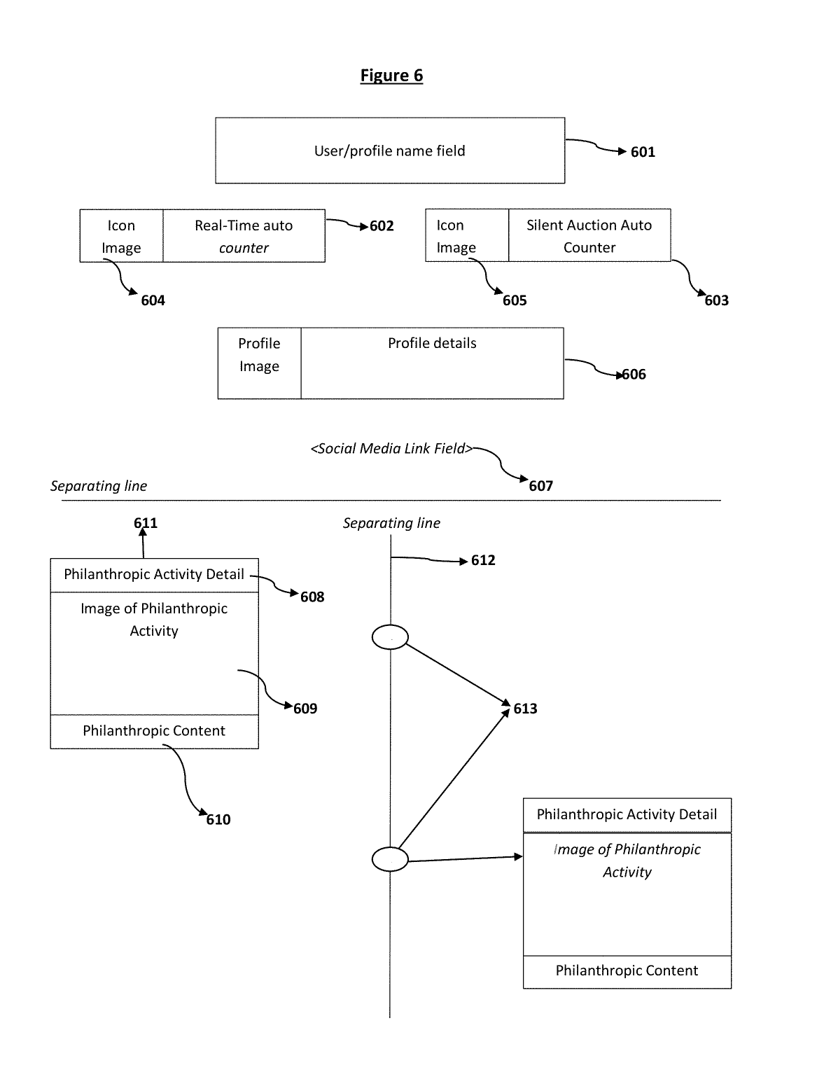

In this way, information from the database is collected and automated into an online socially visible lifetime achievement chronology that is visible online. FIG. 6 elucidates the apparent features of the Lifetime Achievement Award as it appears on the user's profile page. As shown in FIG. 6, the online page shows a user name field 601 on the top of the page where the user's name or profile name appears that will identify for whom the Life-Time-Achievement Line is meant for. It is followed by two adjacent blocks 602 and 603 showing real time count of the money being raised through campaigns and auctions respectively. The real time count is facilitated by an inbuilt software algorithm that triggers in a “page load” event of the Life-Time-Achievement-Line page to cause the following software code checks in the database:

a. who is the current user profile being viewed?
b. which campaigns and auctions did the user created?
c. what contributions were made in campaigns which the user participated in and those which the user did not create?
d. Then, add up the results yielded in Step (b, and c) and show on the page.

Information about raised funds in item 602 gives an automatic and updated accounting of funds raised by the user through fundraising activities. Information about raised funds in item 603 gives an automatic and real-time accounting in monetary form of funds raised by the user/profile in silent auction activities. Both these information automatically updates when new philanthropic data enters the database which allows the Life-time-achievement-award to evolve on a single page when new philanthropic information becomes available. A page-load event causes an updated tally to display award with new/updated data.

In the preferred embodiment, real time fund count is accompanied by icon Images 604 and 605 in the form of logos which gives visual representation of the content that is being displayed in the respective blocks. This is followed by the profile details of the user 606 and social media link field 607. The next part then exhibits philanthropic details including, but not limited to, the philanthropic activity 608 (at the top of the block), image of philanthropic activity 609, philanthropic content 610 in the form of blocks 611 containing relevant information about a particular philanthropic activity in a chronological order 612 separated by timestamps 613 at regular intervals with the most recent activity being shown on the top. Chronological order is achieved through the following logic: Every auction and campaign a person creates has a timestamp, i.e. date-time of when that item was created. When a campaign, auction, or donation is recorded on the database, the database logs the time the entry was recorded and displays it on the user's profile in a chronological order starting from top to bottom. In other embodiment, the logos, the blocks and the timestamps can be replaced by any suitable indicator to facilitate proper display of the real time fund count.

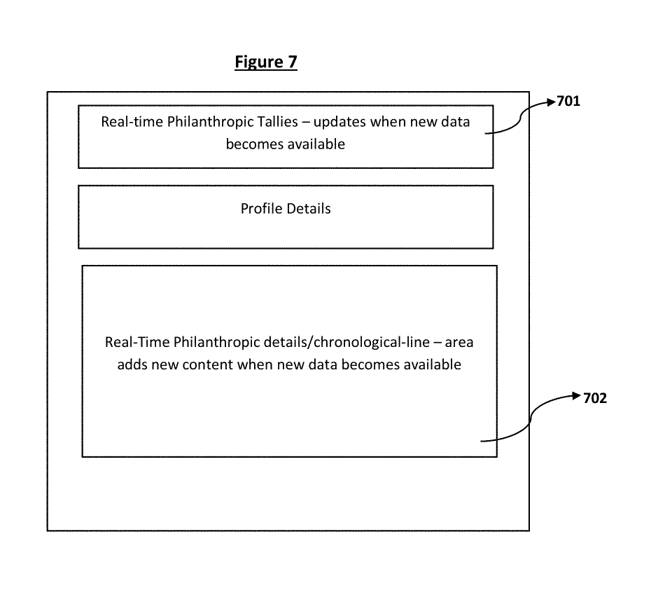

In a seamless fashion, the lifetime achievement award expands with the number of philanthropic engagements and thus keeps expanding with the new philanthropic data being updated. As shown in FIG. 7, this gives a schematic view of the award as it appears on the user's profile page, section showing the status of Philanthropic tallies 701 updates itself. Similarly, the section showing details of the philanthropic activity 702 also updates itself by adding new content as and when new data becomes available. The real time count is facilitated by an inbuilt software algorithm that is triggered with a “page load” event of the Life-Time-Achievement-Line page which will cause the following software code checks in the database:

a. who is the current user profile being viewed?
b. which campaigns and auctions did the user create?
c. which campaigns did the user participate in that the user did not create?
d. Then, add up the results yielded in Step (b and c) and show on the page.

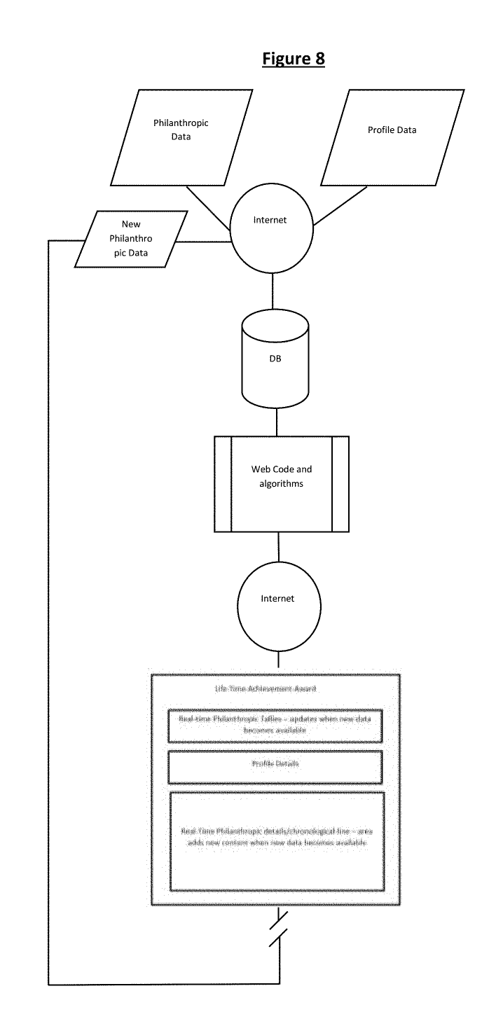

The evolving nature of award thus addresses the need for issuing separate awards for separate contributions. As per the earlier FIG. 6, item 602, 603, 608, 609, 610, 611, 612 and 613 will auto populate together when new philanthropic data becomes available on the database with previous mentioned program logic. This allows the Lifetime achievement award to expand on a single page when new philanthropic activity becomes available. New philanthropic data also undergoes the same process of web coding and algorithm and gets placed in the chronology on a particular timestamp. FIG. 8 gives a holistic analysis of the present invention by giving details of the lifetime achievement award in the whole process.

The award itself acts as a Social Currency. An interested entity can thus decide about making a business engagement by choosing the company that best suits its philanthropic endeavors. Two companies that are not well-known can develop a “social currency” by cultivating a Life-Time-Achievement Line through its philanthropic endeavors. Any third party person/entity trying to decide to go with company A or B may choose the company it best identifies with in philanthropic endeavors.

There is no stringent rule as far as the usage of database or the visual layout of the award is concerned. In the preferred embodiment, SQL database would suffice, but other database systems and formats, including non-relational ones may be used. Same rule will be applicable for other system components like operating systems also. The invention can be run on Windows, Ubuntu, Linux, ios or any other Operating System.

We claim:

1. A method for developing an online automated socially accessible philanthropic chronological profile that displays record of a user's philanthropic activities, the method including the steps of:
Allowing creation of an online social cause on a user profile;
Maintaining a database that keeps a record of the philanthropic activities of individual users registered on a computer network;
Updating user's philanthropic contributions on the computer network and displaying the updated activities on the user's profile page in a linear fashion.

2. The method as stated in claim 1, where the philanthropic activity without limitation includes, social campaigns and auctions.

3. The method as stated in claim 1, where the step of creation of user profile is created from the information selected from a group consisting of user's name, organization details and contact details.

4. The method as stated in claim 1, where the profile can be accessed via public internet through HTTP and IP protocols.

5. The method as stated in claim 1, where user's philanthropic contributions are listed in a linear chronology, starting from the date on which first contribution was made.

6. The method as stated in claim 1, where user's philanthropic contributions are separated from each other through time-stamps.

7. The method as stated in claim 1, where there are separate recognitions for auctions and campaigns.

8. The method as stated in claim 1, where the step of updating user's philanthropic contribution comprises a step of automatic and real time accounting of funds raised in philanthropic activities.

9. The method as stated in claim 1 where data relating to user's philanthropic contribution updates when new data becomes available.
